(19) United States
(12) Patent Application Publication
(10) Pub. No.: US 2020/0080671 A1
(43) Pub. Date: Mar. 12, 2020

(54) FITTING SPANNER

(71) Applicant: Mueller Industries, Inc., Memphis, TN (US)

(72) Inventors: John ATKINSON, Nashville, TN (US); Justin GAST, Memphis, TN (US); Christopher MUELLER, Collierville, TN (US)

(21) Appl. No.: 16/124,749

(22) Filed: Sep. 7, 2018

(51) Int. Cl. F16L 21/00; F16L 13/14; B23P 17/00

(52) U.S. Cl. CPC F16L 21/00; B23P 17/00; F16L 13/141

(57) ABSTRACT

A fitting spanner configured to couple a first fitting and a second fitting that are separated by a gap having a length that is less than a diameter of an insertion end of each of the first and second fittings. The fitting spanner includes a tubular body having a first end and a second end that are each pre-finished to be devoid of burrs and sharp edges, and an alignment element is positioned between the first end and the second end that is configured to properly align the fitting spanner between the first fitting and the second fitting. The alignment element is a permanent visual indicator provided on the tubular body, wherein the tubular body includes a length and diameter that is selected based on the diameter and a length of the insertion end of the first fitting and the second fitting that is configured for receipt of the fitting spanner.

### FIELD

The present disclosure relates to a fitting spanner.

### BACKGROUND

This section provides background information related to the present disclosure which is not necessarily prior art.

It is common to join a pair of fittings with a fitting spanner, which is a relatively shorter section of pipe. In the past, an installer was required to manufacture his or her own fitting spanner from elongated sections of pipe that were in his or her possession by measuring a length of fitting spanner that was required, and then cutting the fitting spanner from the elongated section of pipe. Oftentimes, however, the length of the fitting spanner can be miscalculated or the fitting spanner is inadvertently cut at a non-perpendicular angle that prevents the fitting spanner from being properly seated in the fitting, which requires the installer to manufacture another fitting spanner and waste time and material. Moreover, the terminal ends of the pipe become roughened due to the formation of burrs that form during the cutting process, which requires the installer to polish and sand the ends of fitting spanner. If the fitting spanner is to be used in a tight space, the fitting spanner can have a very short length. Due to the short length, it may be relatively difficult for the installer to grip the fitting spanner and remove the burrs, which also leads to wasted time and material.

In addition, if one or both of the ends of the fitting spanner manufactured by the installer is not fully inserted into one or both of the fittings, there is an increased likelihood that when the fittings are crimped to the fitting spanner, an improper seal may be formed. That is, a sufficient amount of the fitting spanner should be inserted into each of the fittings to ensure that the ends of the fitting spanner are crimped along with the inlet or outlet of the respective fitting. If a sufficient length of the fitting spanner is not properly inserted into the fitting, the end of the fitting spanner located within one of the fittings may not be crimped correctly, which may result in an improper seal.

### SUMMARY

This section provides a general summary of the disclosure, and is not a comprehensive disclosure of its full scope or all of its features.

The present disclosure provides a fitting spanner configured to couple a first fitting and a second fitting that are separated by a gap having a length that is less than a diameter of an insertion end of each of the first and second fittings. The fitting spanner includes a tubular body having a first end and a second end that are each pre-finished to be devoid of burrs and sharp edges, and an alignment element is positioned between the first end and the second end that is configured to properly align the fitting spanner between the first fitting and the second fitting. The alignment element is a permanent visual indicator provided on the tubular body, wherein the tubular body includes a length and diameter that is selected based on the diameter and a length of the insertion end of the first fitting and the second fitting that is configured for receipt of the fitting spanner.

The present disclosure also provides a method of manufacturing a fitting spanner that is configured to couple a first fitting to a second fitting that are separated by a gap having a length that is less than a diameter of an insertion end of each of the first and second fittings. The method includes providing a tube having a first length; cutting the tube into a plurality of tubes having a second length that is less than the first length; polishing the opposing ends of each of the plurality of tubes having the second length to remove any burrs or imperfections therefrom that were created during the cutting; and forming an alignment element on each of the plurality of tubes by forming a permanent visual indicator about a circumference of the tubes.

Lastly, the present disclosure provides a method of coupling a first fitting to a second fitting. The method includes determining whether the first fitting and the second fitting are separated by a gap having a length that is less than a diameter of an insertion end of each of the first and second fittings; selecting a fitting spanner from a plurality of pre-manufactured fitting spanners based on the gap, as well as a diameter and length of the insertion end each of the first fitting and the second fitting that are configured for receipt of the fitting spanner, each of the pre-manufactured fitting spanners including a permanent visual indicator that serves as an alignment element that is configured to properly mate the fitting spanner relative to each of the first fitting and the second fitting; mating each of the first fitting and the second fitting to the fitting spanner such that the alignment element remains visible; and crimping the insertion ends of the first and second fittings and the fitting spanner, wherein the alignment element is either a pre-manufactured groove that is radially recessed into the fitting spanner about a circumference of the fitting spanner or a pre-manufactured ridge that radially protrudes outward from the fitting spanner about the circumference of the fitting spanner.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a fitting spanner according to a principle of the present disclosure;

FIG. 2 is a cross-sectional view of the fitting spanner illustrated in FIG. 1;

FIG. 3 is an axial view of the fitting spanner illustrated in FIGS. 1 and 2;

FIG. 4 is a cross-sectional view of an alternative configuration for a fitting spanner according to a principle of the present disclosure;

FIG. 5 is an exploded perspective view of a joint between a pair of fittings that are to be connected by a fitting spanner according to a principle of the present disclosure, in an unconnected state;

FIG. 6 is a perspective view of the joint illustrated in FIG. 5, in a connected state;

FIG. 7 is a perspective view of a properly connected joint between two fittings that utilizes a fitting spanner according to a principle of the present disclosure;

FIG. 8 is another perspective view of a properly connected joint between two fittings that utilizes a fitting spanner according to a principle of the present disclosure;

FIG. 9 is another perspective view of an improperly connected joint between two fittings that utilizes a conventional fitting spanner;

FIG. 10 is a perspective view of an installation of various fittings that are connected at a plurality of joints by fitting spanners according to a principle of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

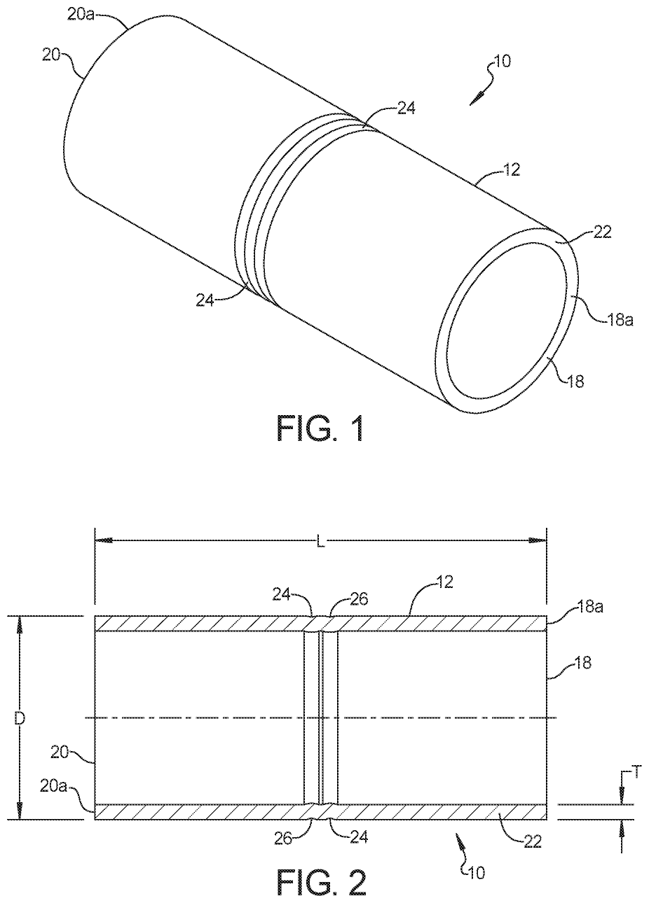

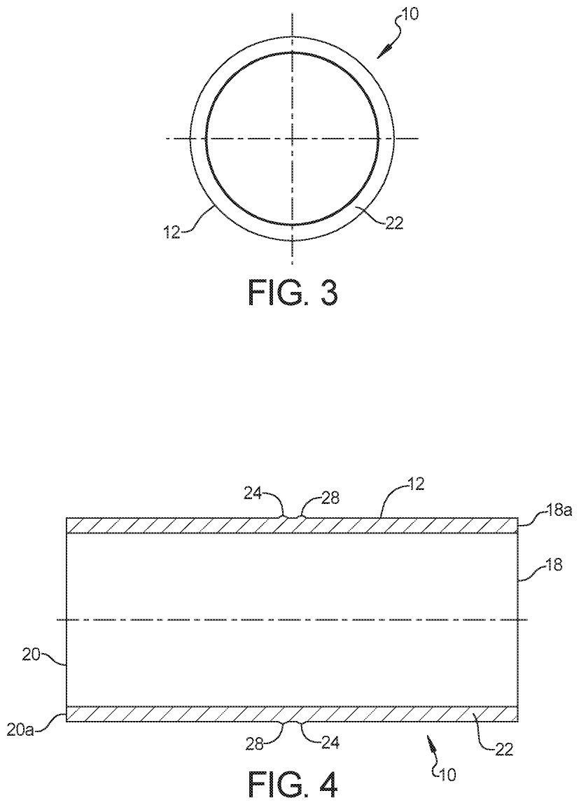

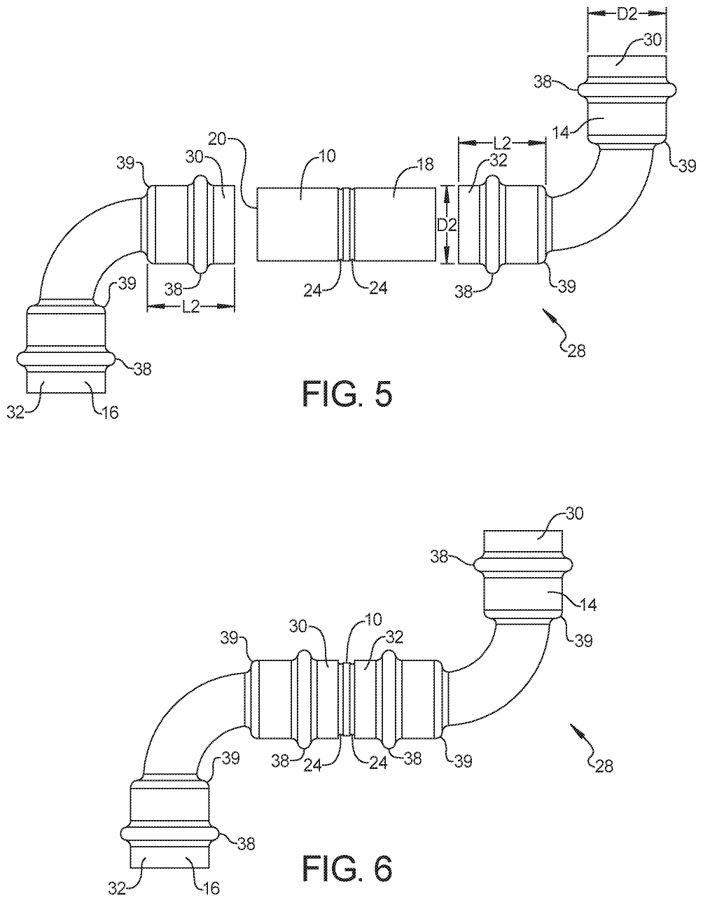

A fitting spanner 10 according to the present disclosure is illustrated in FIGS. 1-4. Fitting spanner 10 includes a tubular body 12, which is generally a cylindrical fitting, tube, or pipe that is configured to function as a coupling between a pair of fittings 14 and 16, as best illustrated in FIGS. 5 and 6. Pipe 12 of fitting spanner 10 has a first end 18 and a second end 20. First end 18 is configured to mate with fitting 14, and second end 20 is configured to mate with fitting 16. First end 18 defines an annular surface 18a, and second end 20 defines an annular surface 20a. When fitting spanner 10 is properly cut during manufacture thereof, annular surface 18a and annular surface 20a are parallel to each other, and arranged orthogonal to tubular body 12. After fitting spanner 10 is mated with fittings 14 and 16, fittings 14 and 16 may be crimped to ensure a fluid-tight connection between fitting spanner 10 and each of the fittings 14 and 16, as is known in the art.

Fitting spanner 10 may be formed of a material similar to that which forms fittings 14 and 16. For example, if fittings 14 and 16 are formed of copper, fitting spanner 10 may also be formed of copper. Other materials include, for example, aluminum, steel, or any other material that is known to one skilled in the art. Pipe 12 has a length L that is suitable for the location at which fittings 14 and 16 are located. That is, if the joint between fittings 14 and 16 is at a location that is relatively “tight” (i.e., in a small space) or closely spaced, the pipe 12 will have a length that is relatively short. A “tight” or closely spaced location between fittings 14 and 16 is defined as a gap between the fittings 14 and 16 that is less than a diameter of the fittings 14 and 16 that are to be joined by the fitting spanner 10. For example, if a diameter of fittings 14 and 16 is one inch, a distance between the fittings 14 and 16 that will be occupied by fitting spanner 10 will be less than one inch to be considered a “tight” or closely spaced location. In contrast, if the joint between fittings 14 and 16 is at a location that is not considered “tight” or closely spaced, pipe 12 can be designed to have a greater length L. Pipe 12 may also have a diameter D that is selected based on a diameter of the fittings 14 and 16 that are to be coupled by fitting spanner 10. A wall 22 of pipe 12 has a thickness T that is selected based on the application for which fittings 14 and 16 are designed. More particularly, if fittings 14 and 16 are designed to carry a fluid under high pressure, it may be desirable for thickness T to be greater than in, for example, an application where fluid is carried by fittings 14 and 16 at low pressure.

Fitting spanner 10 is a pre-manufactured device. In this regard, fitting spanner 10 may be manufactured from substantially longer sections of pipe 12 that may be precisely cut at the desired length L. After each fitting spanner 10 is separated from the longer section of pipe 12, first and second ends 18 and 20 including parallel annular surfaces 18a and 20a are subjected to a finishing process where the first and second ends 18 and 20 are de-burred and polished. This provides a fitting spanner 10 that is better suited to provide a fluid-tight seal between fittings 14 and 16 after a correct length of fitting spanner 1 is inserted into fittings 14 and 16 and crimped to fittings 14 and 16.

More particularly, in the past, an installer was required to manufacture his or her own fitting spanners from elongated sections of pipe that were in his or her possession by measuring a length of fitting spanner that was required, and then cutting the fitting spanner from the elongated section of pipe. Oftentimes, however, the length of the fitting spanner can be miscalculated or the fitting spanner is inadvertently cut at a non-perpendicular angle that prevents the fitting spanner from being properly seated in the fitting, which requires the installer to manufacture another fitting spanner and waste time and material. Moreover, the terminal ends of the pipe become roughened due to the formation of burrs that form during the cutting process, which requires the installer to polish and sand the ends of fitting spanner. If the fitting spanner is to be used in a tight space, the fitting spanner can have a very short length. Due to the short length, it may be relatively difficult for the installer to grip the fitting spanner and remove the burrs. Thus, because fitting spanner 10 is a pre-manufactured device that is cut at each end 18 and 20 to provide annular surfaces 18a and 20a that are parallel, de-burred and polished before use, the installer is no longer required to conduct a cutting and polishing process, nor be concerned that fitting spanner 10 will not be properly seated within fittings 14 and 16, which saves the installer significant amounts of time, and reduces unnecessary waste.

In addition, fitting spanner 10 may be provided as part of a package where multiple fitting spanners 10 having different lengths L, diameters D, and thicknesses T are provided. For example, a plurality of fitting spanners 10 may be provided that have a diameter D that ranges between about 0.250 inches and about 4.5 inches, a length L that ranges between about 1.00 inches and about 7.50 inches, and a thickness that ranges between about 0.020 inches to about 0.150 inches. By providing multiple fitting spanners 10 in a single package, the installer may have a pre-manufactured fitting spanner 10 on hand for virtually any type of joint. Alternatively, it is contemplated that separate packages can be sold including a plurality of fitting spanners 10 having the same length L, diameter D, and thickness T. For example, the installer may have a package of fitting spanners 10 that each have a length L of about 2.00 inches, a diameter D of about 1 inch, and a thickness T of about 0.060 inches, another package of fitting spanners 10 that each have a length L of about 4.00 inches, a diameter D of about 2 inches, and a thickness T of about 0.080 inches, and so on. It should be understood, however, that these examples are non-limiting, and one skilled in the art would be able to select the appropriate dimensions as desired.

It should also be understood that fitting spanners 10, as best shown in FIGS. 1 and 2, are provided with at least one permanent visual indicator that serves as an alignment element 24. As best illustrated in FIG. 2, fitting spanner 10 is provided with a pair of alignment elements 24, which are in the form of grooves 26 that are recessed into wall 22. Although alignment elements 24 are each illustrated as being a groove 26, the present disclosure should not be limited to such a configuration. Indeed, alignment element 24 can instead be a ridge 25 (FIG. 4). Alternatively, alignment element 24 may be a solid or dashed line that is formed of a permanent ink that is printed or painted onto pipe 12. Other alternatives for forming alignment element(s) 24 include laser etching, knurling, discoloration, or any other method that can form a permanent visual indicator that serves as alignment element 24. Regardless, alignment elements 24 are provided to ensure that a sufficient amount of fitting spanner 10 is mated with each fitting 14 and 16 such that fittings 14 and 16 may be sufficiently crimped to fitting spanner 10 to ensure a leak-proof seal.

Moreover, while fitting spanner 10 is illustrated as having a pair of alignment elements 24, it should be understood that fitting spanner 10 may be provided with only a single alignment element 24 or with a number of alignment elements 24 greater than two without departing from the scope of the present disclosure. As will be discussed in more detail below, however, the use of two alignment elements 24 is more advantageous.

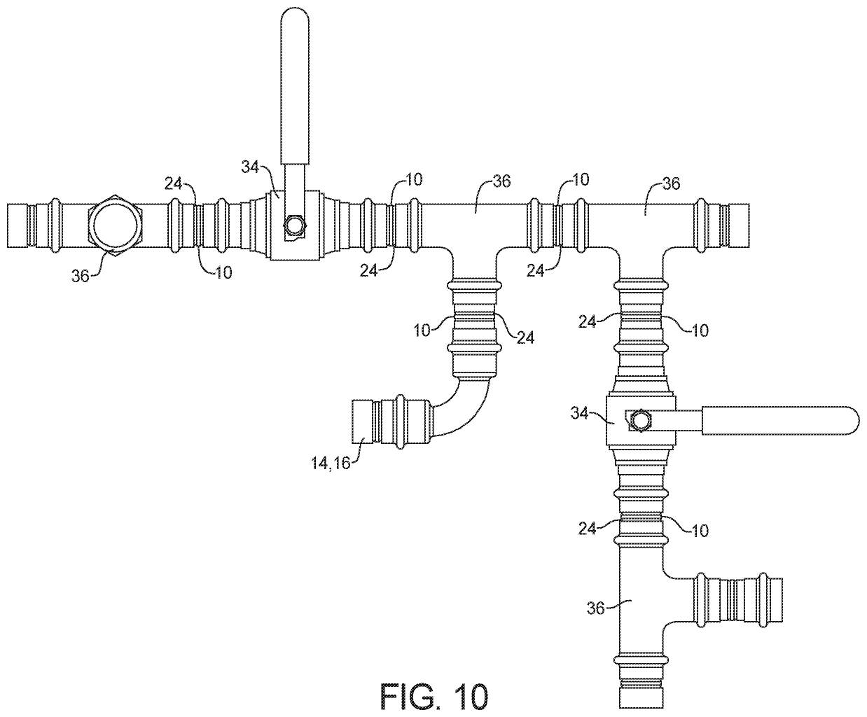

FIGS. 5 and 6 illustrate a tight or closely spaced joint 28 between a pair of fittings 14 and 16 that utilizes fitting spanner 10 according to the present disclosure. FIG. 5 illustrates joint 28 before fittings 14 and 16 and fitting spanner are crimped, while FIG. 6 illustrates joint 28 after fittings 14 and 16 have been coupled to each other using fitting spanner 10, and subsequently crimped to provide a leak-proof seal. Each fitting 14 and 16 includes an inlet 30 and an outlet 32 having a diameter D2, with outlet 32 of fitting 14 being coupled via fitting spanner 10 to inlet 30 of fitting 16. In the example joint 28 illustrated, each fitting 14 and 16 is an elbow-type of fitting. It should be understood, however, that fitting 14 and 16 may alternatively be a valve 34 (see, e.g., FIG. 10), a reducer fitting (not shown), a T-type of fitting 36 (see, e.g., FIG. 10), or any other type of fitting known to one skilled in the art without departing from the scope of the present disclosure. Regardless, inboard from inlet 30 and outlet 32, fittings 14 and 16 each include a radially expanded portion 38 that is configured for receipt within the jaws of a crimping tool (not shown) that ensures that the fitting 14 or 16 may be satisfactorily crimped to fitting spanner 10. Moreover, it should be understood that downstream from inlet 30 and upstream from outlet 32, a diameter of the fittings 14 and 16 radially narrows. The location 39 where inlet 30 and outlet 32 radially narrow serves a stop for the ends 18 and 20 of fitting spanner 10 when fitting spanner 10 is mated with fittings 14 and 16.

Fitting spanner 10 is selected for joint 28 based on the location where joint 28 will be located, and the diameter D2 of the fittings 14 and 16. For example, referring to FIG. 10, an installation in, for example, a utility closet is illustrated that includes a plurality of fittings 14 and 16 that are joined by fitting spanners 10. The installation illustrated in FIG. 10 is designed for a tight or close space and, therefore, requires the fittings 14 and 16 to be as close together as possible, which in turn requires fitting spanners 10 having a relative short length. Accordingly, the installer selects a pre-manufactured fitting spanner 10 having a length L such that when the selected fitting spanner 10 is mated with fittings 14 and 16 the ends 18 and 20 will reach stops 39, which results in a sufficient amount of the fitting spanner 10 being located on either side of radially expanded portion 38 of fittings 14 and 16 so that when fittings 14 or 16 are crimped to fitting spanner 10, the fitting spanner 10 and will be compressed by the crimping tool on each side of the radially expanded portion 38. That is, the length L of fitting spanner 10 is selected based on the length L2 of the inlet 30 and outlet 32. To ensure that a sufficient length of fitting spanner 10 is provided on each side of radially expanded portion 38, the installer inserts fitting spanner 10 into the inlet 30 or outlet 32 of the fitting 14 or 16 to an extent that ends 18 and 20 reach the stops 29, and at least one alignment element 24 remains visible.

Preferably, when fitting spanner 10 is inserted into inlet 30 or outlet 32, the alignment element 24 is located just outboard from either the inlet 30 or outlet 32 of the fitting 14 or 16, as shown in FIG. 6. After fitting spanner 10 is properly mated to fittings 14 and 16, fittings 14 and 16 are crimped to fitting spanner 10. Although it is preferable that each alignment element 24 remains visible to ensure proper mating with fittings 14 and 16, it should be understood that when fitting spanner 10 includes a pair of alignment elements 24, only a single alignment element 24 is necessary to remain visible before crimping fittings 14 and 16 to fitting spanner 10. That is, it is contemplated that one of the alignment elements 24 may be obscured from view by inlet 30 or outlet 32, while still maintaining proper mating and crimping of fitting spanner 10 with fittings 14 and 16.

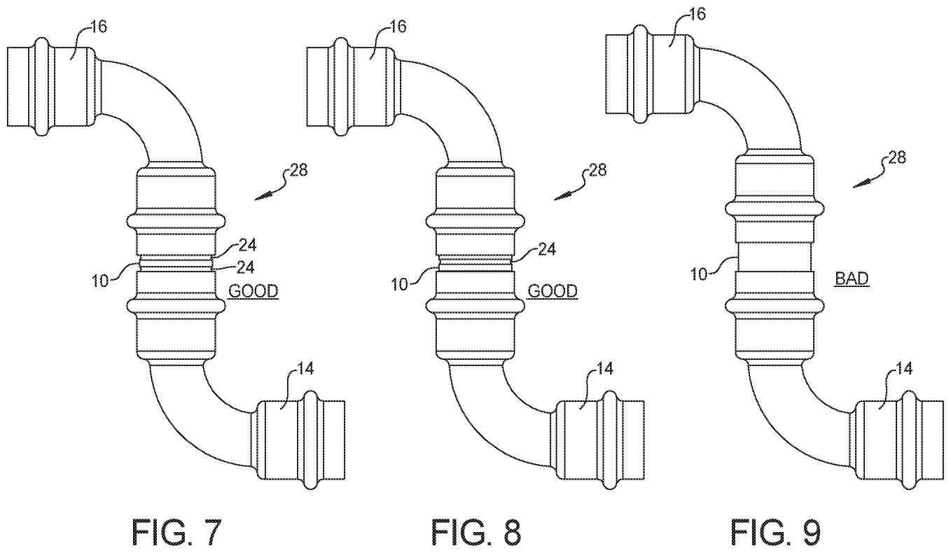

FIG. 7 illustrates a properly fitted joint 28 that utilizes fitting spanner 10 between fittings 14 and 16. As illustrated in FIG. 7, it can be seen that alignment elements 24 are each visible when fitting spanner 10 is properly mated with fittings 14 and 16. Similarly, referring to FIG. 8, it can be seen that joint 28 is properly fitted using fitting spanner 10 even when only a single alignment element 24 is visible. In contrast, as shown in FIG. 9, no alignment elements 24 are visible, which indicates that fittings 14 and 16 may be improperly coupled using fitting spanner 10. That is, when alignment elements 24 are not visible, it cannot be determined whether a sufficient length of fitting spanner 10 has been fully inserted into, and therefore mated with, one of the fittings 14 and 16 such that, when the joint 28 is crimped, an improper seal may develop. Moreover, if at least one of the alignment elements 24 is not visible, the fittings 14 and 16 may be located too close together such that when fitting 14 is crimped to fitting spanner 10, the crimp between fitting 14 and fitting spanner 10 may be damaged when fitting 16 is subsequently crimped to fitting spanner 10. If one of the crimps is damaged by a subsequent crimping operation, the fluid-tight seal between fitting spanner 10 and one of the fittings 14 and 16 may be compromised.

As noted above, fitting spanner 10 is a pre-manufactured device that does not require any cutting from a length of pipe or post-treatment of the ends 18 and 20 of the fitting spanner 10. The installer, therefore, can simply select the proper fitting spanner 10 for the joint 28 based on the length L2 and diameter D2 of the inlet 30 and outlet 32 of the fittings 14 and 16 that are used for the joint 28, align the fittings 14 and 16 relative to fitting spanner 10 using alignment elements 24, and then crimp the fittings 14 and 16 to fitting spanner 10 to create the leak-proof seal. Because the installer does not have to manufacture a fitting spanner in the field, a substantial time savings is achieved and unnecessary waste is avoided, which results in increased productivity. In addition, there is a substantially reduced likelihood of improper crimping between the fittings 14 and 16 and the fitting spanner 10 due to the imprecise insertion of fitting spanner 10 into fittings 14 and 16 prior to crimping.

FIG. 10 illustrates an example application where a plurality of various types of fittings 14, 34, and 36 are connected by fitting spanners 10 according to the present disclosure. As shown in FIG. 10, a number of fitting spanners 10 are required to connect the plurality of fittings 14, 34, and 36 in a very tight space. Nonetheless, because the alignment elements 24 are visible, the installer is aware that a sufficient amount of the fitting spanners 10 are inserted into and thus properly mated with the respective fittings 14, 34, and 36 such that when the fittings 14, 34, and 36 are crimped to the fitting spanners 10, a fluid tight seal can be made between the fitting spanners 10 and each of the fittings 14, 34, and 36.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A fitting spanner configured to couple a first fitting and a second fitting that are separated by a gap having a length that is less than a diameter of an insertion end of each of the first and second fittings, the fitting spanner comprising:
a tubular body having a first end and a second end that are each pre-finished to be devoid of burrs and sharp edges, and
at least one alignment element positioned between the first end and the second end that is configured to properly align the fitting spanner between the first fitting and the second fitting, the alignment element being a permanent visual indicator provided on the tubular body,
wherein the tubular body includes a length and diameter that is selected based on the diameter and a length of the insertion end of the first fitting and the second fitting that is configured for receipt of the fitting spanner.

2. The fitting spanner of claim 1, wherein the at least one alignment element is defined by a groove that is recessed radially into the tubular body and formed about a circumference of the tubular body.

3. The fitting spanner of claim 2, wherein the at least one alignment element includes a pair of the grooves, which are formed about the circumference of the tubular body.

4. The fitting spanner of claim 1, wherein the at least one alignment element is defined by a ridge that protrudes radially from the tubular body and is formed about a circumference of the tubular body.

5. The fitting spanner according to claim 4, wherein the at least one alignment includes a pair of the ridges, which are formed about a circumference of the tubular body.

6. The fitting spanner according to claim 1, wherein the permanent visual indicator is formed by laser etching the tubular body, providing a permanent ink on the tubular body, knurling the tubular body, or providing a discoloration on the tubular body.

7. The fitting spanner according to claim 1, wherein each of the first and second ends defines an annular surface, and each of the annular surfaces are arranged parallel to each other, and orthogonal to the length of the tubular body.

8. A method of manufacturing a fitting spanner that is configured to couple a first fitting to a second fitting that are separated by a gap having a length that is less than a diameter of an insertion end of each of the first and second fittings, comprising:
providing a tube having a first length;
cutting the tube into a plurality of tubes having a second length that is less than the first length;
polishing the opposing ends of each of the plurality of tubes having the second length to remove any burrs or imperfections therefrom that were created during the cutting;
forming at least one an alignment element on each of the plurality of tubes by forming a permanent visual indicator about a circumference of the tubes.

9. The method according to claim 8, further comprising forming at least a pair of alignment elements on each of the plurality of tubes.

10. The method according to claim 9, wherein the alignment elements are provided at a central location of each of the tubes, and are axially spaced apart from each other.

11. The method according to claim 9, wherein the alignment elements are each a groove that is radially recessed into the plurality of tubes.

12. The method according to claim 9, wherein the alignment elements are each a ridge that protrudes radially outward from each of the plurality of tubes.

13. The method according to claim 9, wherein the alignment elements are each formed by laser etching the plurality of tubes, providing a permanent ink on the plurality of tubes, knurling the plurality of tubes, or by providing a discoloration on the plurality of tubes.

14. The method according to claim 8, wherein the opposing ends of each of the plurality of tubes define annular surfaces that are arranged parallel to each other, and orthogonal to the second length of the plurality of tubes.

15. A method of coupling a first fitting to a second fitting, comprising:
determining whether the first fitting and the second fitting are separated by a gap having a length that is less than a diameter of an insertion end of each of the first and second fittings;
selecting a fitting spanner from a plurality of pre-manufactured fitting spanners based on the gap, as well as a diameter and length of the insertion end each of the first fitting and the second fitting that are configured for receipt of the fitting spanner, each of the pre-manufactured fitting spanners including at least one permanent visual indicator that serves as an alignment element that is configured to properly mate the fitting spanner relative to each of the first fitting and the second fitting;
mating each of the first fitting and the second fitting to the fitting spanner such that the alignment element remains visible; and
crimping the insertion ends of the first and second fittings and the fitting spanner,
wherein the alignment element is either at least one pre-manufactured groove that is radially recessed into the fitting spanner about a circumference of the fitting spanner or at least one pre-manufactured ridge that radially protrudes outward from the fitting spanner about the circumference of the fitting spanner.

16. The method according to claim 15, wherein the pre-manufactured fitting spanners are devoid of any burrs or imperfections.

17. The method according to claim 15, wherein the alignment element includes at least a pair of the grooves.

18. The method according to claim 15, wherein the alignment element includes at least a pair of the ridges.

19. The method according to claim 17, wherein during the mating, at least one of the grooves is visible.

20. The method according to claim 18, wherein during the mating, each of the ridges are visible.
